(19) United States
(12) Patent Application Publication
(10) Pub. No.: US 2016/0355446 A1
(43) Pub. Date: Dec. 8, 2016

(54) APPARATUS FOR COMPOSTING ORGANIC MATTER

(71) Applicant: Christopher Wilkinson, Brooklyn, NY (US)

(72) Inventor: Christopher Wilkinson, Brooklyn, NY (US)

(21) Appl. No.: 15/170,291

(22) Filed: Jun. 1, 2016

Related U.S. Application Data
(60) Provisional application No. 62/169,827, filed on Jun. 2, 2015.

(51) Int. Cl. C05F 17/02

(52) U.S. Cl. CPC C05F 17/0211; C05F 17/0264

(57) ABSTRACT

A composter for various organic debris is designed to remove such debris, namely yard waste and other organic materials, and promote an effective composting process. The composter may have a device mounted thereon to collect leaves, grasses, soil, and the like. A liquid treatment may be applied to the ground organic material to enhance the decomposition process. A heat treatment may also be applied to the organic matter. Other treatments may also be necessary depending on the intended results and the type of organic matter being processed. The composter may further then be capable of spreading the compost over a desired area either immediately or once sufficiently decomposed. The composter may be controlled via an application or via a built in interface.

### CLAIM OF PRIORITY

This application claims priority to U.S. application Ser. No. 62/169,827 filed on Jun. 2, 2015, the contents of which are herein fully incorporated by reference in its entirety.

### FIELD OF THE EMBODIMENTS

The field of the invention and its embodiments relate to an apparatus that is capable of removing organic matter from a property and storing/processing this matter for some duration of time. In particular, the present invention permits the removal of leaves, soil, grass, and other organic materials, processes these materials, and then returns the processed material to the environment to decompose and provide nutrients to the surrounding area.

### BACKGROUND OF THE EMBODIMENTS

Property owners often place a premium on having an aesthetically pleasing piece of property free of debris and other refuse. In order to maintain a property in such a state, it is required of the landowner, throughout the year (especially in summer and fall), to collect organic waste such as leaves, grass, branches, and other such materials to be bagged and subsequently thrown away. However, this creates waste that is usually taken to a dump or is simply left sitting in the way of foot-traffic around a property. A superior alternative is to create compost to be placed over areas of the property to stimulate growth of foliage to enhance these natural aesthetics. Further, compost can be used in lieu of harmful fertilizers.

Compost comprises organic matter that has decomposed over a time of weeks and months turning it into humus. Often times, it is not desirable to wait such durations and people turn to quicker alternatives. Thus, the composting process can be expedited via close monitoring of the addition of a fluid, such as water, shredding the material to be composted, and ensuring the material is receiving the proper aeration. Proper ratios of these components should allow temperatures above 135° F. to be obtained and maintained naturally by the decomposing matter. This can greatly decrease the duration of the composting process.

However, in order to achieve such expeditious time frames, the compost must be closely monitored as noted above. For example, the most efficient composting occurs with a carbon to nitrogen ratio of about 30:1. If too much oxygen or water enters the system, the composting process can further be slowed. Additionally, shredding of the organic matter helps to increase the rate of decomposition, but can be a laborious manual process.

In light of the aforementioned difficulties of achieving a desirable compost in a time efficient manner, it is apparent that the current technology needs to meet these needs. Thus, such technology should allow for the shredding, mixing, and addition of materials to the compost as needed. Further, such technology should remove the laborious effort of collecting materials, such as yard waste, to be added to an area designated for composting. These present invention and its embodiments meets and exceeds these objectives.

Review of related technology:

U.S. Pat. No. 7,654,480 pertains to a mulcher that has a base unit and a shredding blade in a removable assembly. Two different embodiments are disclosed. In both embodiments, shredded material is removed from air exiting the shredding blade before it reaches an exhaust port. In one embodiment, the material is removed by a filter. In the other embodiment, walls are arranged so that debris must double back against high-speed airflow leaving the shredding blade before exiting the unit. The shredding blade can be mounted in front of and on the same shaft as an air impeller, with the back surface of the shredding blade being supported by the impeller. In another embodiment, the air impeller and the shredding blade are carried in assemblies that are separable from each other and are each separately attachable to a base unit. A detachable power module and a detachable blower are also shown. The power module has a safety switch that disables the power module when it is removed. A power receptacle is shown with a switch that alternately switches power to either the shredder motor or to the power receptacle, but not to both simultaneously.

U.S. Pat. No. 5,215,267 pertains to a composter for composting organic yard and household debris. The composter has an enclosure, a feed opening, a discharge opening, an internal breaking and mixing assembly. The enclosure is made of durable red cedar and a bottom member can be a perforated fiberglass with moisture collection valleys and perforations to drain excess moisture.

U.S. Patent Application 2006/0172411 pertains to a composter intended primarily for composting household waste, i.e. organic waste such as food waste and the like. To this end, the composter comprises a rotatable drum with an inlet at an upstream end thereof and an outlet at a downstream end thereof, whereby, when the composter is in use, household waste placed in the composter at the inlet is caused to progress in stages from the upstream end thereof towards the downstream end thereof whereat the composted household waste may be removed at the outlet. The rotatable drum is of polygonal cross section, i.e. the drum is ten sided in order to facilitate periodic rotation of the drum between successive ones of its ten sides over a period of time. The inlet is mounted on the upstream end of the drum for orientation into an upright position after each rotational movement of the drum. Internally, the drum is provided with a series of deflector means for ensuring that the waste material is directed downstream away from the inlet and towards the outlet as the drum is rotated. The composter, which is molded from plastic material, is provided with a receptacle for the recovery of leachate. Alternative uses of the composter includes the propagation of earth worms for fishermen.

Various devices are known in the art. However, their structure and means of operation are substantially different from the present disclosure. The other inventions fail to solve all the problems taught by the present disclosure. The present invention and its embodiments provide for an autonomous vehicle that is capable of traveling a predetermined course and collecting organic materials. The organic materials are then processed to increase the rate of decomposition and returned to the environment to provide nutrients to the surrounding area. At least one embodiment of this invention is presented in the drawings below and will be described in more detail herein.

### SUMMARY OF THE EMBODIMENTS

Generally, the present invention and its embodiments provide for an apparatus that expedites and/or enhances the composting of organic matter. Such organic matter may include but is not limited to food waste, human and/or animal waste, plant matter such as grasses, soil, leaves, branches, fungi, and other organics.

The apparatus, in at least one embodiment, is manifested as an autonomous vehicle that employs a suction mechanism to “pick up” organic material or matter from an environment and subsequently process the organic matter internally before returning it to the environment. Once collected by the apparatus, the organic material may be chopped, ground, or otherwise made smaller, have heat applied, and/or have a fluid treatment applied. Other treatments may also occur and are to be contained under the purview of this invention.

Once the organic matter has been subjected to the desired treatment process, it then exits the apparatus through an outlet and is deposited back into the environment. The organic matter is then allowed to remain and serve as compost for the particular environment. In some embodiments, the apparatus may travel over the same environment over a time period (i.e. every two weeks) to process the organic matter for a subsequent time.

As described above, the apparatus is preferably an autonomous vehicle. The apparatus has a mechanism that permits travel of the apparatus through an environment, such as a property, which may manifest itself as wheels, treads, or other mechanisms of mobility. The apparatus is preferably outfitted with a number of sensors to help prevent the apparatus from crashing into trees, people, animals, and other obstacles.

In some embodiments, the apparatus may be capable of “learning” a particular route associated with an environment to prevent such collisions. The apparatus may interface with any number of satellites including those responsible for the global positioning system (GPS). The apparatus may also be capable of communicating with an electronic device such as a lap top computer, desktop computer, multimedia player, gaming system, smart phone, smart watch, and the like or any combination thereof. The electronic device, in some instances, may be capable of controlling the apparatus and its functionality.

In one embodiment there is an apparatus for processing of organic matter, the apparatus comprising: a container structure having at least two internal compartments, wherein one of the at least two internal compartments is configured to provide a fluid treatment to the organic matter; a transport system that directs the organic matter into at least one of the at least two internal compartments; and a transport mechanism that enables transfer of the organic matter from one of the at least two internal compartments to another of the least two compartments.

In another embodiment of the present invention there is an apparatus for processing of organic matter having a base comprising a base support and at least three wheels; a motor and a generator coupled to the base support; a container structure situated on the base support the apparatus having a container structure having at least one inlet, at least one outlet, and at least two internal compartments, wherein one of the at least two internal compartments has at least one heating element, and wherein one of the at least two internal compartments has at least one fluid dispersal mechanism; a suction mechanism that directs the organic matter into the at least one inlet; a rotary cutting mechanism that processes the organic matter; a transport mechanism that enables transfer of the organic matter from one of the at least two internal compartments to another of the least two compartments; and a forced air system comprising at least two forced air blowers; wherein processed organic matter exits the apparatus via the at least one outlet.

In yet another embodiment of the present invention there is an apparatus for processing of organic matter, the apparatus having a container structure having at least one inlet, at least one outlet, and at least two internal compartments, wherein one of the at least two internal compartments has more than one heating element, and wherein one of the at least two internal compartments has at least one fluid dispersal system; an access door that enables access to one of the at least two internal compartments; a suction mechanism that directs the organic matter into the at least one inlet; a rotary cutting mechanism located in a proximity to the suction mechanism that processes the organic matter; a transport mechanism that enables transfer of the organic matter from one of the at least two internal compartments to another of the least two compartments; a control system comprising at least an input and a display; a forced air system comprising at least two forced air blowers; and wherein processed organic matter exits the apparatus via the at least one outlet.

In general, the present invention succeeds in conferring the following, and others not mentioned, benefits and objectives.

It is an object of the present invention to provide an apparatus that operates autonomously.

It is an object of the present invention to provide an apparatus that processes organic matter.

It is an object of the present invention to provide an apparatus that expedites and/or enhances the composting of organic matter.

It is an object of the present invention to provide an apparatus that applies heat and/or cooling to organic matter.

It is an object of the present invention to provide an apparatus that applies a fluid treatment to the organic matter.

It is an object of the present invention to provide an apparatus that cuts, chops, minces, or otherwise breaks down the organic matter.

It is an object of the present invention to provide an apparatus that supplies compost to an environment.

It is an object of the present invention to provide an apparatus that applies a specific protocol to organic matter within a contained, mobile unit.

### BRIEF DESCRIPTION OF THE DRAWINGS

FIG. 1 is a perspective view of an embodiment of the present invention.

FIG. 2 is a side view of an embodiment of the present invention.

FIG. 3 is a cutaway side view of an embodiment of the present invention.

FIG. 4 is a schematic demonstrating a pathway the organic material travels from the point of collection to the return of the organic material to the environment.

FIG. 5 is an example of a display screen for interacting with embodiments of the present invention.

FIG. 6 is a perspective view of another embodiment of the present invention.

FIG. 7 is a cutaway side view of another embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

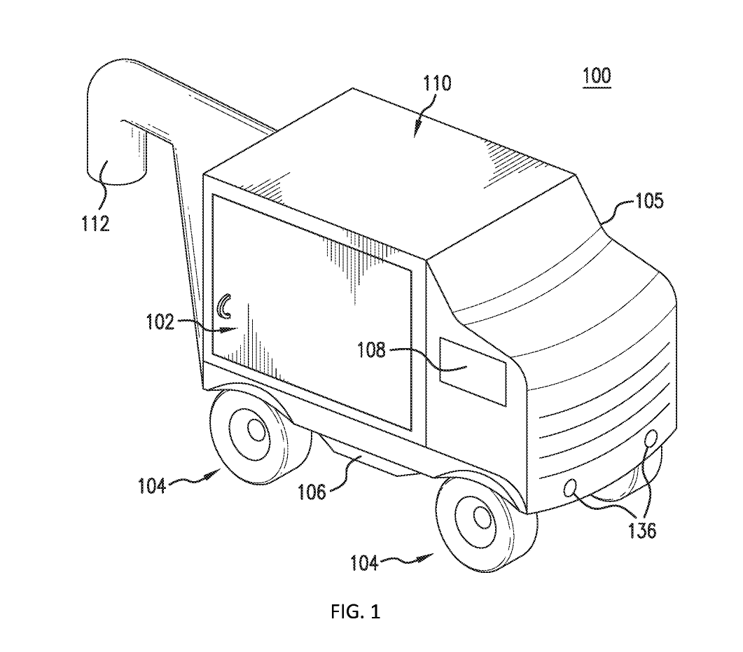

Referring now to FIG. 1, there is a perspective view of an embodiment of the apparatus 100. Generally, the apparatus 100 has a body 105 with a container 110, an access door 102, an outlet 112, wheels 104, a control system 108, sensors 136, and a suction mechanism 106. The exact appearance of the apparatus 100 may vary and there may be different locations for the parts shown and others not explicitly described herein. The apparatus 100 may take the form of a vehicle and may be of generally a solid construction albeit for the access door 102. This is due to the fact it is preferable to have the apparatus 100 operate autonomously thereby removing the need for abundant interior access and controls.

The wheels 104 may each be capable of independently rotating and turning in relation to one another thereby allowing the apparatus 100 to reach virtually any area of one's yard, landscape, or the like. Further, the wheels 104 may have treads to help it grip and maneuver through a variety of terrains.

The sensors 136 may be proximity sensors that are capable of supplying information to the apparatus 100. The apparatus 100 may have a global positioning system (GPS), as described further below, that is used for navigational purposes to define its geographic boundary for operation. However, the GPS cannot take into account various obstacles including temporary obstacles such as a chair that has been positioned in its path or a resting household pet. Thus, the sensors 136 can determine through a variety of mechanisms known in the art whether there is an obstacle and the proper procedure to take to avoid the obstacle. In some instances, the apparatus 100 will simply avoid or go around the obstacle, whereas in other instances the apparatus 100 will re-route itself and return later to see if the obstacle has been cleared. The sensors 136 may be disposed on any surface or combination of surface of the apparatus 100

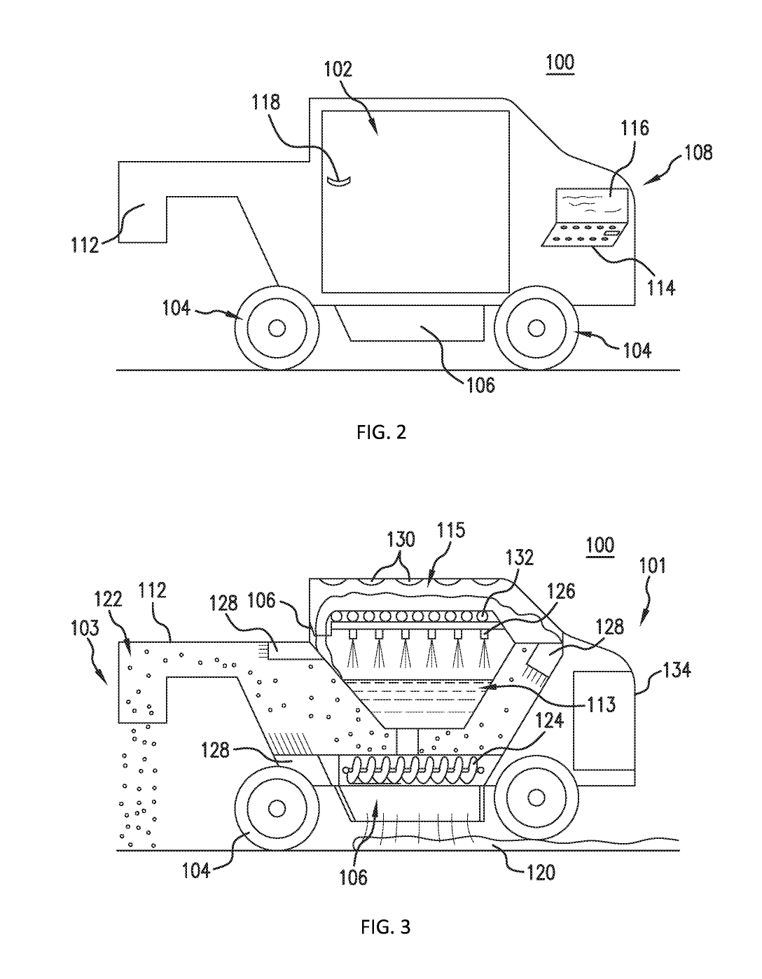

In FIG. 2, there is a side view of the apparatus 100. Here, shown is the access door 102, handle 118, control system 108, wheels 104, suction mechanism 106, and outlet 112. The control system 108 may comprise at least an input 114 and a display 116.

The input 114 is preferably a touch sensitive keyboard which enables the input of commands and other directives into the apparatus 100. Navigational mechanisms on the input 114 may further provide assistance in making adjustments to the apparatus 100. The display 116 may be a liquid crystal display (LCD) or other suitable interface for communicating the operations and settings of the apparatus 100. An electronic device such as a lap top computer, desktop computer, multimedia player, gaming system, smart phone, smart watch, and the like or any combination thereof. The electronic device may be capable of communicating with the control system 108 thereby enabling remote monitoring and/or control of the apparatus 100 via the electronic device.

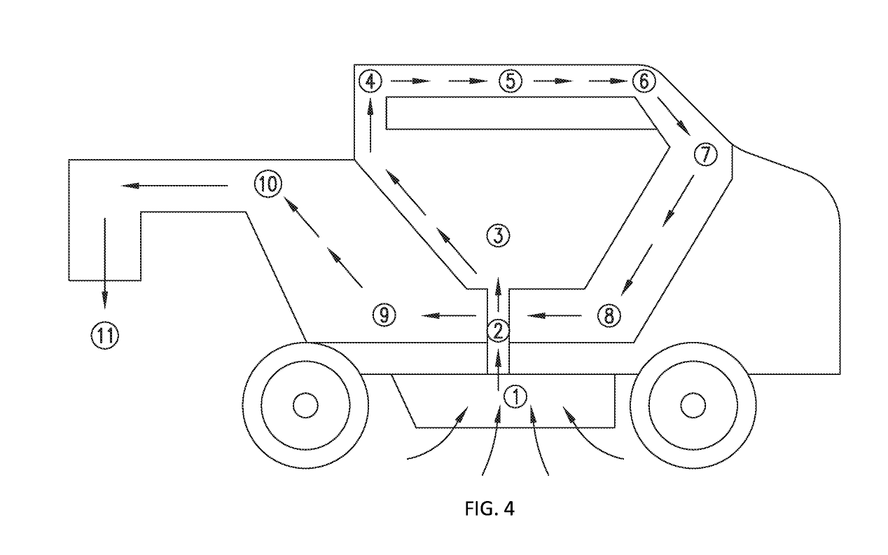

FIG. 3 demonstrates at least some of the internal components of the apparatus 100 via a cutaway side view of the apparatus 100. The suction mechanism 106 resides in the lower portion of the apparatus 100. Namely, the suction mechanism 106 provides a conical or similarly shaped extension that extends below the main structure of the apparatus 100. The suction mechanism 106 preferably uses a motor to and an air pump to generate a partial vacuum thereby enabling organic matter 120 to be brought into the apparatus 100.

In some configurations, the suction mechanism 106 may be capable of being directionally aimed in order to target certain areas for collecting materials. In some instances, there may be a plow or plowing system positioned on an underside of the apparatus 100. This may be located behind the suction mechanism 106 to allow compost material to be deposited into the plowed area. Yet in other embodiments, there may be a guard positioned on a front lower end of the apparatus 100. This guard may articulating to allow for compressing piles of leaves, clippings, and other matter to direct them under the apparatus 100 without impeding the movement of the apparatus 100. In yet other embodiments, a manual suction mechanism may be coupled to the device and operated manually to reach places (i.e. between trees) where the apparatus 100 may be incapable of traversing. In other embodiments, other appropriate mechanisms and methods for creating suction may also be employed.

The organic matter 120 is then refined by the cutting mechanism 124. In some embodiments, the cutting mechanism 124 may not be the first “treatment” protocol encountered by the organic material 120. The cutting mechanism 124 may be any combination of blades and/or cutting edges and may preferably be a rotary cutting blade. The cut or chopped organic matter 120 may be held in a first compartment 113 for some duration of time. The first compartment 113 may have any number of water jets 126 or fluid dispersal mechanisms. Water is applied to the organic material 120 via these water jets 126. The apparatus 100 may have a tank or reservoir to hold water (not shown), and the apparatus 100 may be capable of recycling the water used therein for multiple cycles through the apparatus 100.

Further, the water jets 126 may apply other liquids (other than water) or provide water that has dissolved or otherwise integrated compounds therein. Some examples of materials the water jets 126 are capable of dispensing include, but are not limited to water, calcium nitrate, ammonia sulfate, ammonia nitrate, nitrogen, sugars, ammonia, or any combination thereof. The ratios between these various compounds may be varied as necessary depending on the type of organic material 120 to be collected and the processing methodology.

In some embodiments, there may be a mixing or agitating apparatus that ensures complete and proper coverage of such a treatment to the organic material 120. For example, the first compartment 113 may take the form of a rotary drum with the water jets 126 disposed around an inside of the drum. As the drum rotates, the organic material 120 is tumbled and mixed with the liquid treatment. A spiral blade may be further disposed therein capable of causing the organic material 120 to remain in the drum for treatment or causing it to be “pushed” out of the drum via the blades to be transported to another area or section of the apparatus 100.

In some embodiments, a separate suction mechanism 106 draws the moistened organic material 120 into a second compartment 115. In other embodiments, the weight of the organic material 120 is such that a forced air blower may be necessary to transport the organic material 120 into the second compartment 115. In the second compartment 115, a conveyor 132 transports the organic material 120 in a proximity to at least one heating element 130. The at least one heating element 130 may be capable of heating the organic material 120 to a temperature of about 40° C. to about 65° C.

In some embodiments, there is a setting that allows for burning or other destruction of the matter in the event a storage capacity or clog or the like is determined to have been met. In such embodiments and others, it is desirable to have a filtering mechanism to permit as little environmental contamination as possible from the processing process.

The conveyor 132 may be capable of being programmed to travel at various speeds thereby increasing the length of time the organic material spends in the second compartment 115. As noted, heat via a heating element 130 is applied in this compartment. The heating to be supplied may vary by temperature and time and may be dependent on the applied compounds from the first compartment 113. Thus, the speed of the conveyor should be selected to allow for proper treatment of the organic material 120 to promote and/or enhance composting of the material.

The apparatus 100 may then use gravity or other transport means, such as a secondary conveyor, to transport organic matter 120 on a path out of the apparatus 100. Forced air blowers 128 are strategically positioned and designed to force the now processed organic matter 122 towards the back end 103 of the apparatus 100 where the outlet 112 resides. The forced air blowers 128 may have independent settings enabling them to operates at different levels or speeds from another blower. In some instances, certain blowers can be turned off while others remain functional. The settings may be dependent on the organic material contained therein and the desired distance for the material to travel to be deposited once it leaves the outlet 112. The outlet 112 then permits the processed organic material 122 to be returned to the environment. The outlet 112 serves as a conduit to return to the processed organic matter 122 to the environment. The outlet 112 generally is a tubular member that is pointed at the ground level to ensure the processed organic material 122 is returned to the environment. In some instances, the outlet 112 is capable of being articulated to direct the processed organic material 122 to a particular area. The apparatus 100 may be capable of adjusting the articulation of the outlet 112 as it progresses through its route or course setting to ensure proper depositing of the processed organic material 122.

In some embodiments, the outlet 112 is attached to a bag or cart that is configured to receive the processed organic material. This enables the processed material to be bagged and stored, sold, or the like. This may also enable a singular place of storage for the compost which may then be manually placed over specific areas of the environment. Further, by storing the compost in a central location, the composting process may be sped up.

The apparatus 100 and its components operates by way of an energy source 134 which may manifest itself as a combustion engine or battery operated motor. In some instances solar paneling or other renewable energy apparatus may be used to further provide power to the apparatus 100 as well as aid in the composting process.

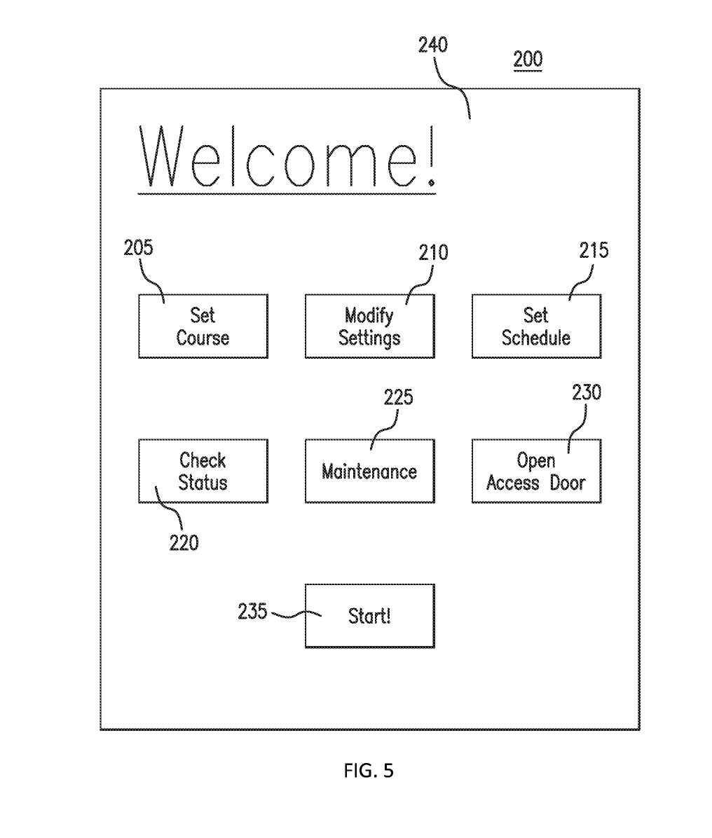

FIG. 4 highlights an exemplary pathway of the organic material as it passes through the apparatus as described in FIG. 3. At point 1, the organic material is brought into the apparatus via the suction mechanism. At point 2, the organic material has been refined by the cutting mechanism and is travelling through a passageway linking the first compartment with the outer confines of the apparatus.

Once in the first compartment, at point 3, the first round of treatments is applied to the organic material. Depending on the treatment(s) to be applied, the material may instantly move to the second compartment or may remain in the first compartment for some length of time. At point 4, the organic material is sucked or blown into the second compartment. A heat treatment is applied at point 5. There may be temperature gradients at certain points in this compartment in order to cause certain processes or desired results. For example, an additive from the first compartment may require a particular temperature to be activated which it receives in the second compartment.

At point 6, the processed organic material is ready to exit the apparatus. Along points 7-10 forced air blowers or other mechanisms of movement are strategically located to guide the processed organic material out of the apparatus via the outlet. At point 11, the processed organic material exits the outlet to be returned to the environment to supply vital nutrients to promote plant growth, soil nutrition, and the like.

Referring now to FIG. 5, there is an exemplary screen that may greet a user upon the display 116 (see FIG. 2) to enable the user to modify and otherwise manipulate the apparatus.

Here, the screen 200 has a display screen 240. Located on the display screen 240 are a number of selectable icons which may direct the user to a secondary screen(s) or may open up a menu for selections to be made. The screen may be touch sensitive and support touchscreen technologies. An input 114 (see FIG. 2) may also assist the user in navigating and otherwise interacting with the apparatus. The shown icons are meant to be exemplary only and the actual icons may be the same or different as described. Further, the functionality and menu tree associated with each icon may be the same or different and some functionality described under one icon may actually reside under another. As noted, this screen may also be reached from an electronic device employing a web or mobile based application and providing the same functionality and control.

The set course 205 enables a user to modify, create, delete, or otherwise makes changes to a course setting of the apparatus. The course may be set initially via coordinates, geo-fencing, or the like or some combination thereof. In some instances, one may have to manually guide the apparatus through the desired course in order to for the apparatus to “learn” the course. Once the course is set, is can be saved in a system memory and be modified at a future time and date as needed. Multiple course profiles may be capable of being stored thus enabling quick one touch selection of a desired area for the apparatus to treat. The set course feature operates in conjunction with the sensors 136 discussed in FIG. 1. This enables complete automation of the apparatus thereby saving an individual precious time from having to collect and maintain their own compost.

The modify settings 210 can be used to modify most any general settings as applicable to the apparatus. This may include the particular treatment(s) to be applied to the organic material, the amount of suction generated by the suction mechanism, the speed at which the apparatus is to travel, sensitivity settings, and the like or any combination thereof. Some such functionality has been otherwise discussed herein and other functionality may be prescribed that is not specifically contemplated herein but is contained under the purview of this invention.

The set schedule 215 allows for a fixed schedule to be set for the apparatus to operate under. Thus, a real time clock, stored in the on-board programming, may enable the apparatus to treat certain areas at certain dates and times dependent on the scheduled settings. Course selections may be selected from under this setting to allow for importing of saved courses enabling certain courses to be run during a certain time or date.

The check status 220 enables the user to graphically view any of the systems in order inspect the apparatus as a whole to ensure that the apparatus is functioning correctly. Various system readouts such as fluid levels, fuel or battery levels, temperatures, and the like can be viewed and modified as need be.

The maintenance 225 enables warnings or alerts to be broadcast to the user to signify that an action needs to be taken in order to ensure the proper functioning of the apparatus. Such warnings may include a lack of required fluids, a caught or stuck component, a non-operative component, or other malfunction recognized by the system.

The open access door 230 enables any locking mechanism to be released enabling the access door to be opened. This provides access to the interior of the apparatus but also can prevent unintentional opening of the access door which could result in injury or decreased performance by the apparatus (i.e. loss of suction).

The start 235 enables the apparatus to start running a specific protocol in conjunction with the aforementioned settings, courses, etc.

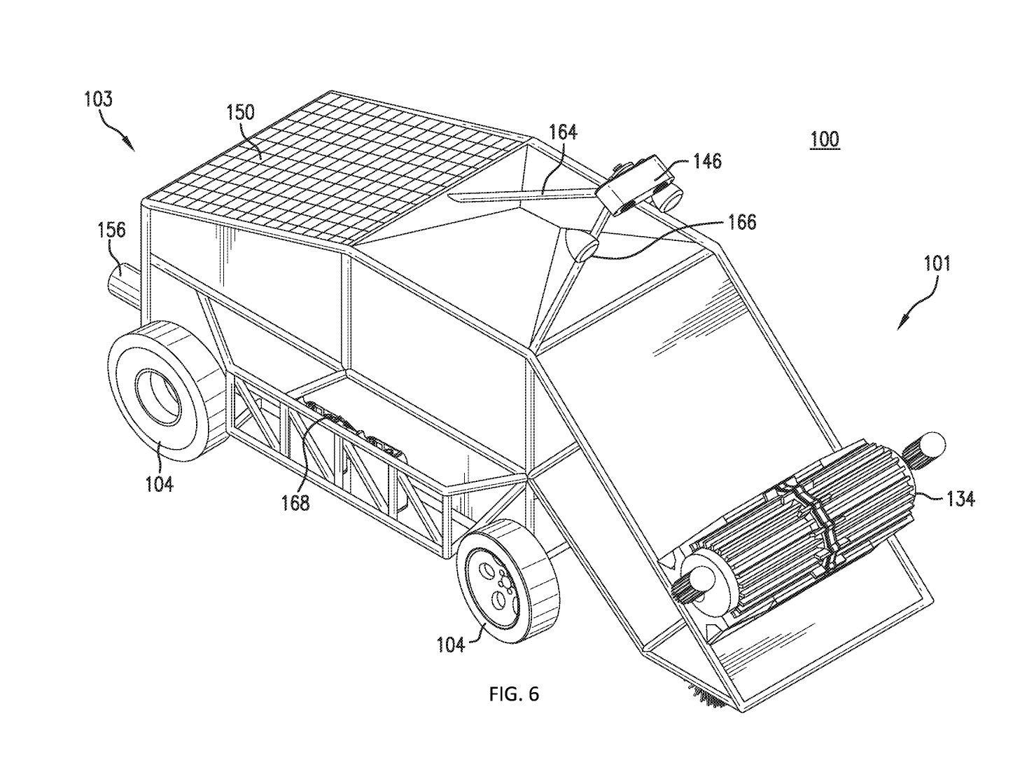

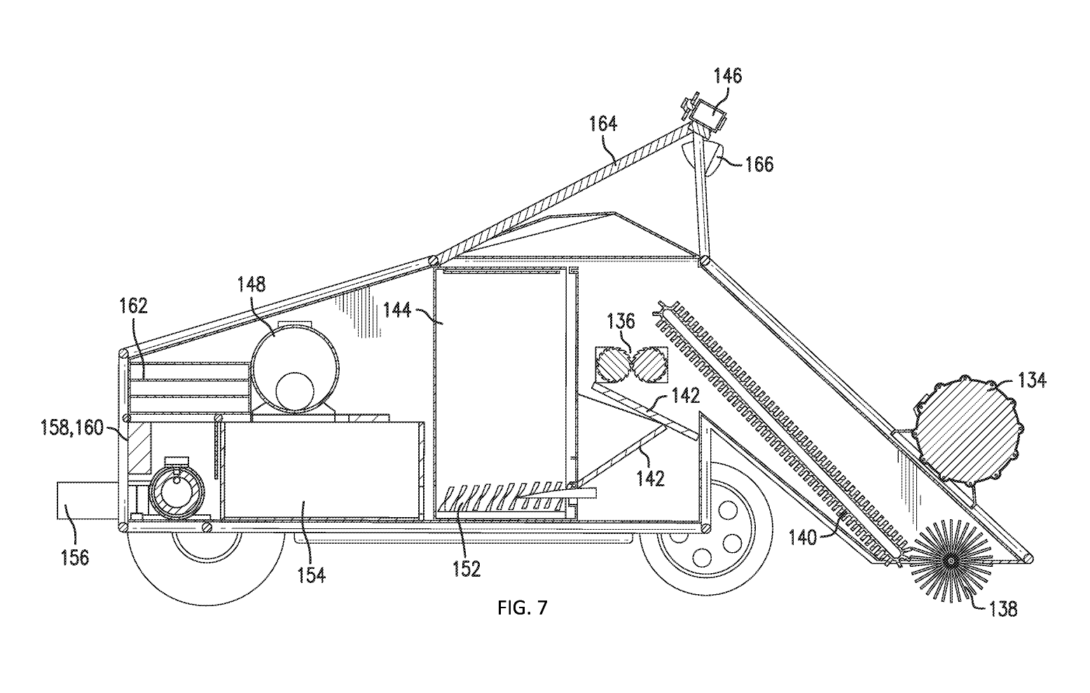

Referring now to FIGS. 6-7, there is another embodiment of the present invention. At a front end 101 are the elements/mechanism used to gather up the organic matter from the surrounding environment. There may be a rotating brush 138 that sweeps up material onto a conveyor belt 140 for transport into the apparatus 100. Further, there may be a pair of suction pumps or suction mechanisms 134 that help vacuum up the material from the ground or brush 138 and cause it to settle onto the conveyor belt 140. The suction mechanism(s) 134 may further have a grill or screen that prevents material from going through the internal housing of the suction mechanism 134 and instead allows the suctioned material to fall back onto the conveyer 140 for transport.

The conveyer 140 then transports the gathered material upwards towards the internal compartments. When the collected material reaches the top of the conveyor belt 140, it is tipped over into a bladed shredder 136. The bladed shredder 136 comprises multiple cutting/grinding blades and is mounted on a spring bearing such that if any non-shreddable material enters, the blades comprising the shredder do not jam but spring or expand apart allowing the non-shreddable material to fall through the bladed shredder 136.

A grid or screen 142 underneath the bladed shredder 136 allows shredded material to pass into the intake hopper or drum 144 while enabling all un-shredded material to be returned to the environment. As such, if a stone or other unsuitable material is accidently picked up by the machine, it passes through the shredding unit without harming it. The processed (shredded) material that passes through the screen 142 falls into a rotating drum 144. The rotating drum 144 has a frame that is of a fine metallic mesh, allowing jets or nozzles to spray fluid onto the processed material through the mesh as the drum rotates and mixes the shredded organic matter. The fluid sprayed onto the shredded organic material may simply be water, or may have additives that are beneficial to the composting process. The additives may, for instance, be calcium nitrate Ca(NO₃)₂, ammonia sulfate, ammonia nitrate, sugars, ammonia, or some combination of these substance. A particular combination may be utilized to help a particular composting process depending on the nature of the material collected by the apparatus 100. This liquid may be stored in the apparatus 100 on the fluid tank 148 which is in fluid connection with the rotating drum 144.

In furtherance of the composting process, there may also be heaters and aerators incorporated into the apparatus 100. These heaters and aerators serve to heat and inject air into the processed material. Favorable conditions for compositing are to have finely divided organic material with a carbon to nitrogen ratio of about 10:1 to about 50:1 and more preferably about 30:1 or less and at a temperature of between 135 to 160 degrees Fahrenheit.

A material transport device, such as an Archimedes screw, may be used to both move material along and out of the rotating drum 144 and can be extended to also transport material into a second storage compartment 154 contained within the apparatus 100. The second storage compartment 154 may be used to store composting material for any length of time, or it may simply be a short-term store before the material is pumped out by a second set of Archimedes screws or transport devices contained within the second storage compartment 154.

The processed material may be pumped out of the second storage compartment 154 and back onto the yard as fertilizer via the outlet 156, or it may be pumped into long term storage containers, or remain in the second storage compartment 154 and allowed to continue to compost.

The rear 103 of the unit, may have a gas powered electric generator 158. This generator 158 provides the electric power to propel the apparatus 100. The electricity from the generator is also used to drive the electric motors 160 that power the rotating brush 138, the suction mechanism 134, the conveyor belt 140, the rotating drum 144, the Archimedes screw or transport device 152, the water sprays, and the heating elements.

In a power outage emergency, the gas powered electric generator can also serve as a backup electricity source for other house hold items.

Further, at the rear 103 of the unit there is also an electronics rack 162. The apparatus 100 is an autonomous vehicle, and the electronics may include digital processors, GPS and Wi-Fi® communication. This allows the apparatus 100 to be operated like a remote control drone by using a computer or smart phone app as described herein. Such an apparatus 100 will be of great utility to elderly or handicapped, allowing them to perform yard work from the comfort of a chair.

In some embodiments, the apparatus 100 may also be programmed to follow a predetermined or learnt path. In other embodiments, the electronics may also implement a geo-fence alarm. This will prevent theft of the apparatus 100 by alerting an owner if the vehicle is moved outside of a predefined geographic location defined by GPS coordinates.

Further, the apparatus 100 may include cameras 146, laser scanning radar and other features similar to that found on, for instance, Google's automatous vehicles, allowing the vehicle to follow preprogramed paths while avoiding obstacles like people or pets. Such equipment may reside on supports 164 to be positioned properly for directing the apparatus 100. The apparatus 100 may also have at least one solar panel 150. The at least one solar panel 150 can augment the power of the electric generator 158, helping make the apparatus 100 “greener” for the environment.

The side panels 168 on the apparatus 100 are useful for storing equipment. This equipment may be gas containers having spare gas for the gas powered electric generator. The side panels 168 may also be a place to house electric batteries either in use or during storage. These batteries may be conventional lead acid batteries, or they may be more sophisticated lithium ion batteries as used in, for instance, Tesla cars.

Further, lighting 166 may be used and may include LEDs, Lasers, infrared, or other technologies allowing a path to be illuminated and causing the apparatus 100 to “see.”

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. An apparatus for processing of organic matter, the apparatus comprising:
a container structure having at least two internal compartments,
wherein one of the at least two internal compartments is configured to provide a fluid treatment to the organic matter;
a transport system that directs the organic matter into at least one of the at least two internal compartments; and
a transport mechanism that enables transfer of the organic matter from one of the at least two internal compartments to another of the least two compartments.

2. The apparatus of claim 1 further comprising a cutting mechanism.

3. The apparatus of claim 2 wherein the cutting mechanism is a helical blade rotatably coupled to the apparatus.

4. The apparatus of claim 1 further comprising an access door,
wherein the access door provides access to the at least one of the at least two internal compartments.

5. The apparatus of claim 1 further comprising a forced air system comprising at least two forced air blowers.

6. The apparatus of claim 1 wherein the fluid treatment is a combination of at least two organic or non-organic compounds or a combination thereof.

7. The apparatus of claim 6 wherein at least one of the compounds is water.

8. The apparatus of claim 1 further comprising a control system.

9. The apparatus of claim 8 wherein the control system comprises at least an input and a display.

10. An apparatus for processing of organic matter, the apparatus comprising:
a base comprising a base support and at least three wheels;
a motor and a generator coupled to the base support;
a container structure situated on the base support and having at least one inlet, at least one outlet, and at least two internal compartments,
wherein one of the at least two internal compartments has at least one fluid dispersal mechanism;
a suction mechanism that directs the organic matter into the at least one inlet;
a cutting mechanism that processes the organic matter;
a transport mechanism that enables transfer of the organic matter from one of the at least two internal compartments to another of the least two compartments; and
wherein processed organic matter exits the apparatus via the at least one outlet.

11. The apparatus of claim 10 further comprising a heating element.

12. The apparatus of claim 11 wherein the heating element is capable of heating the organic material to a temperature of about 40° C. to about 65° C.

13. The apparatus of claim 10 wherein the at least one fluid dispersal mechanism dispenses at least water over of the organic material.

14. The apparatus of claim 13 wherein the at least one fluid dispersal mechanism dispenses water and at least one of calcium nitrate, ammonia sulfate, ammonia nitrate, nitrogen, sugars, ammonia, or any combination thereof.

15. The apparatus of claim 10 wherein the transport mechanism is a screw-type conveyor.

16. The apparatus of claim 10 further comprising a wireless transceiver,
wherein the wireless transceiver enables communication with an electronic device.

17. An apparatus for processing of organic matter, the apparatus comprising:
a base comprising a base support and at least three wheels;
a motor and a generator coupled to the base support;
a container structure having at least one inlet, at least one outlet, and at least two internal compartments,
wherein one of the at least two internal compartments has more than one heating element, and
wherein one of the at least two internal compartments has at least one fluid dispersal system;
an access door that enables access to one of the at least two internal compartments;
a suction mechanism that directs the organic matter into the at least one inlet;
a rotary cutting mechanism located in a proximity to the suction mechanism that processes the organic matter;
a transport mechanism that enables transfer of the organic matter from one of the at least two internal compartments to another of the least two compartments;
a control system comprising at least an input and a display;
a forced air system comprising at least two forced air blowers; and
wherein processed organic matter exits the apparatus via the at least one outlet.

18. The apparatus of claim 16 wherein the apparatus is configured to operate autonomously.

19. The apparatus of claim 16 wherein a specific protocol to be applied to the organic matter is modified via the control system.
